(19) United States
(12) Patent Application Publication
(10) Pub. No.: US 2026/0113814 A1
(43) Pub. Date: Apr. 23, 2026

(54) METHODS AND SYSTEMS FOR CONTROLLING A TEMPERATURE OF A GLASS PANEL

(71) Applicant: J.B. Poindexter & Company, Houston, TX (US)

(72) Inventors: J. Erik Hellstrom, Houston, TX (US); Adam Klauer, Houston, TX (US)

(21) Appl. No.: 19/366,089

(22) Filed: Oct. 22, 2025

Related U.S. Application Data
(60) Provisional application No. 63/710,976, filed on Oct. 23, 2024.

(51) Int. Cl. H05B 3/84; H05B 1/02

(52) U.S. Cl. CPC H05B 3/84; H05B 1/0236; H05B 2203/035

(57) ABSTRACT

Methods and systems are described that are configured for controlling the temperature of a glass panel of a vehicle by controlling a heating wire to heat the glass panel. A computing device may generate a filter that may be configured to output a temperature value associated with an exterior surface of the glass panel. The computing device may iteratively tune and update the filter based on measuring environmental values, temperature values, and resistance values at different time points. Based on the tuned and updated filter, the computing device may determine a temperature value associated with the exterior surface of the glass panel based on a resistance value associated with the wire and cause the wire to adjust a heat output to the glass panel.

### CROSS-REFERENCE TO RELATED APPLICATION

This application claims priority to and the benefit of the filing date of U.S. Provisional Patent Application No. 63/710,976, filed Oct. 23, 2024, the entirety of which is hereby incorporated by reference herein.

### BACKGROUND

Glass panels with integrated heating elements are commonly used in vehicles to prevent ice formation and remove condensation that can obstruct visibility. These heated glass systems typically employ thin resistive heating elements, such as transparent conductive films or wire networks, that are embedded within or applied to the glass structure. These heated glass systems are often utilized in applications where occlusion resulting from environmental and temperature conditions, such as frost and liquid condensate, must be mitigated and energy efficiency is desirable. Such glass panels are used in vehicles such as delivery or cargo vehicles, automobiles, airplanes, boats, etc. and are generally composed of two or more glass layers on opposing sides of a metallic heating element layer, which itself can consist of some substrate of an array of thin resistive heating elements running between a panel's top and bottom edges.

The heating capacity of these glass panels has traditionally been limited to relatively low energy density to ensure there is no damage to the panel resulting from over-temperature operation, which can result in delamination of the glass panel, discoloration and loss of transparency of the heating element layer, among other failure modes. Such a failure would commonly result from the panel continuing to be enabled past the point where the target glass temperature is achieved, or from being operated in an environment where the heating element temperature exceeds its maximum threshold before the desired glass temperature is achieved. In this way, the energy density (and therefore benefits in efficiency) of the panels is currently limited based on the lack of options for self-regulated control.

Conventional glass heating systems rely on simple temperature threshold controls that activate heating elements when ambient conditions suggest the possibility of ice or fog formation. These systems typically use fixed temperature setpoints and predetermined heating cycles that are designed to accommodate worst-case environmental conditions. The heating elements are controlled based on ambient temperature measurements or basic interior temperature sensors, with limited feedback regarding the actual temperature conditions at the glass surface. Many systems rely on proxy measurements or simplified models that may not accurately reflect the true thermal conditions at the glass surface. This can lead to suboptimal heating performance, where insufficient heating fails to prevent ice formation or excessive heating wastes energy and may potentially damage the glass panel or heating elements.

While the temperature of the glass panel is critical to the performance and reliability of the system, accurately determining the temperature has so far required additional sensors and conservative control approaches leading to additional cost, robustness, and lack of performance. The temperature is critical because it needs to be sufficient for fast yet energy-efficient defrosting and demisting while avoiding over temperature conditions of the windshield, which may be destructive to the glass panel's optical properties or heating film of the windshield in such a manner to seriously tint the transparency of the windshield. For example, overheating of a heating element that is suspended in a substrate interlayer between the inner and outer glass panes may cause the substrate to pill and the glass assembly to cloud or delaminate.

### SUMMARY

It is to be understood that both the following general description and the following detailed description are exemplary and explanatory only and are not restrictive.

Methods, systems, and apparatuses for controlling the temperature of a glass panel by using adaptive learning techniques to correlate resistance measurements from a heating wire with actual glass surface temperatures are described. A vehicle (e.g., car, truck, automobile, SUV, electric vehicle, delivery vehicle, cargo vehicle, airplane, boat, etc.) may comprise at least one glass panel (e.g., a windshield, window, glass pane, etc.) and a computing device configured to control a wire (e.g., heating wire, wiggle wire, heating strips, heating network, etc.) of the glass panel to heat the glass panel. The computing device may generate a filter that may be configured to output a temperature value associated with an exterior surface of the glass panel correlated to a resistance value associated with a voltage and current of the wire. The computing device may iteratively tune and update the filter based on measuring one or more environmental values, temperature values, and resistance values at one or more time points. Each iteration of updating the filter may increase an accuracy of the correlation between temperature values and resistance values. As such, the computing device continuously learns from environmental conditions and measurement data to improve the accuracy of temperature estimation over time, allowing for more precise control of the heating wire to optimize energy efficiency while maintaining effective defogging and deicing performance. Based on the updated filter, the computing device may determine a temperature value associated with the exterior surface of the glass panel based on a resistance value associated with the wire. Based on the temperature value associated with the exterior surface of the glass panel, the computing device may cause the wire to adjust heat to the glass panel.

In an embodiment, disclosed is are vehicles comprising a glass panel comprising a wire configured to heat the glass panel, and a computing device in communication with the glass panel, wherein the computing device is configured to generate, based on a resistance value and a temperature value associated with the glass panel, a filter configured to output a temperature value associated with an exterior surface of the glass panel correlated to a resistance value associated with a voltage and current of the wire, iteratively tune the filter based on one or more environmental values associated with an interior of the vehicle, iteratively update the tuned filter based on one or more resistance values and one or more temperature values associated with the glass panel, determine, based on an application of the updated filter to a resistance value, a temperature value associated with the exterior surface of the glass panel, and cause, based on the temperature value associated with the exterior surface of the glass panel, the wire to adjust the heat to the glass panel.

In an embodiment, disclosed are methods comprising generating, by a computing device, based on a resistance value and a temperature value associated with a glass panel of a vehicle, a filter configured to output a temperature value associated with an exterior surface of the glass panel correlated to a resistance value associated with a voltage and current output of a wire of the glass panel, iteratively tuning the filter based on one or more environmental values associated with an interior of the vehicle, iteratively updating the tuned filter based on one or more resistance values and one or more temperature values associated with the glass panel, determining, based on an application of the updated filter to a resistance value, a temperature value associated with the exterior surface of the glass panel, and causing, based on the temperature value associated with the exterior surface of the glass panel, the wire to adjust heat to the glass panel.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system;

FIG. 2 shows an example heating wire configuration;

FIG. 3 shows an example process for determining a temperature;

FIG. 4 shows an example temperature control system;

FIG. 5 shows an example adaptive learning control architecture;

FIGS. 6A-6C show example tables of temperature samples; and

FIG. 7 shows a flowchart of an example method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device.

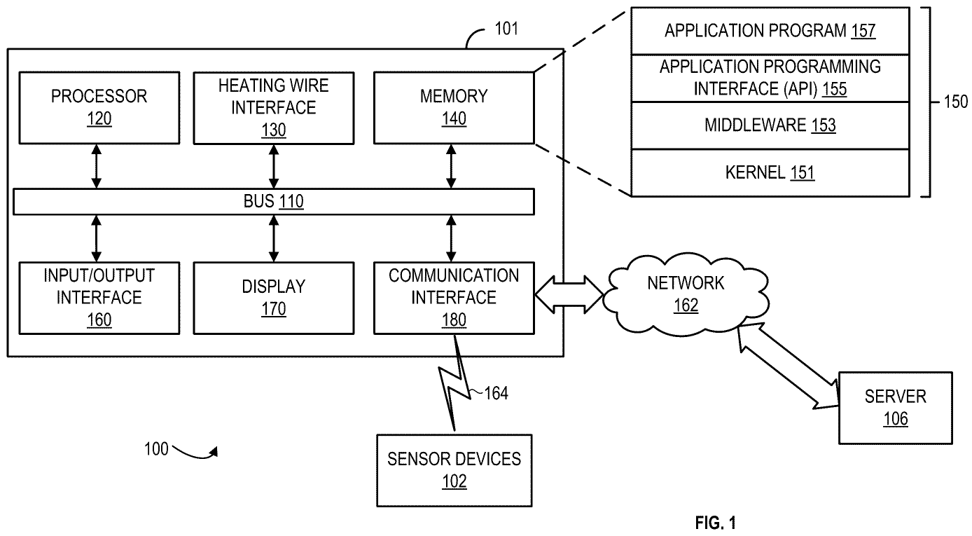

FIG. 1 shows an example system 100 including a computing device 101 configured for controlling a temperature of a glass panel (e.g., a windshield, window, a glass pane, etc.) of a vehicle (e.g., car, truck, automobile, SUV, electric vehicle, delivery vehicle, cargo vehicle, airplane, boat, etc.) based on determining a resistance value of a heating wire (e.g., heating wire, wiggle wire, heating strips, heating network, etc.) of the glass panel according to various embodiments. The computing device 101 may determine the resistance value of the heating wire based on a voltage and current of the heating wire and iteratively update a filter based on one or more resistance values and one or more temperature values associated with the glass panel. The filter may be configure to output a temperature value associated with an exterior surface of the glass panel that is correlated to a resistance value of the heating wire. The computing device 101 may be included in the vehicle. The computing device 101 may include a bus 110, a processor 120, a heating wire interface 130, a memory 140, an input/output interface 160, a display 170, and a communication interface 180. In an example, the computing device 101 may omit at least one of the aforementioned constitutional elements or may additionally include other constitutional elements.

The bus 110 may include a circuit for connecting the processor 120, the heating wire interface 130, the memory 140, the input/output interface 160, the display 170, and the communication interface 180 to each other and for delivering communication (e.g., a control message and/or data) between the processor 120, the heating wire interface 130, the memory 140, the input/output interface 160, the display 170, and the communication interface 180.

The processor 120 may include one or more of a Central Processing Unit (CPU), an Application Processor (AP), and a Communication Processor (CP). The processor 120 may control, for example, at least one of the heating wire interface 130, the memory 140, the input/output interface 160, the display 170, and the communication interface 180 and/or may execute an arithmetic operation or data processing for communication. The processing (or controlling) operation of the processor 120 according to various embodiments is described in detail with reference to the following drawings.

The heating wire interface 130 may be configured as an interface for controlling a heating wire of a glass panel (e.g., a windshield, window, glass pane, etc.) of a vehicle (e.g., car, truck, automobile, SUV, electric vehicle, delivery vehicle, cargo vehicle, airplane, boat, etc.). For example, a glass panel of a vehicle may comprise a heating wire (e.g., wiggle wire, heating strips, heating network, etc.) affixed to a surface of the glass panel. The heating wire may be configured to heat the glass pane. For example, fog or mist may accumulate on the glass panel based on a temperature of the outside environment. The glass panel may be heated, via the heating wire, to defrost or demist the glass panel. As an example, the glass panel may comprise integrated electric heating. For example, the heating wire may comprise a transparent, semi-conductive metal oxide coating that is applied to the glass panel, wherein electricity is passed through the coating from concealed bus bars at the top and bottom of the glass panel. For example, power may be applied to the bus bars to apply power to the heating wire.

The memory 140 may include a volatile and/or non-volatile memory. The memory 140 may store, for example, a command or data related to at least one different constitutional element of the computing device 101. In an example, the memory 140 may store a software and/or a program 150. The program 150 may include, for example, a kernel 151, a middleware 153, an Application Programming Interface (API) 155, and/or an application program (or an “application”) 157, or the like, configured for controlling one or more functions of the computing device 101 and/or an external device (e.g., one or more sensor devices 102). At least one part of the kernel 151, middleware 153, or API 155 may be referred to as an Operating System (OS). The memory 140 may include a computer-readable recording medium having a program recorded therein to perform the method according to various embodiments by the processor 120.

The kernel 151 may control or manage, for example, system resources (e.g., the bus 110, the processor 120, the memory 140, etc.) used to execute an operation or function implemented in other programs (e.g., the middleware 153, the API 155, or the application program 157). Further, the kernel 151 may provide an interface capable of controlling or managing the system resources by accessing individual constitutional elements of the computing device 101 in the middleware 153, the API 155, or the application program 157.

The middleware 153 may perform, for example, a mediation role so that the API 155 or the application program 157 can communicate with the kernel 151 to exchange data.

Further, the middleware 153 may handle one or more task requests received from the application program 157 according to a priority. For example, the middleware 153 may assign a priority of using the system resources (e.g., the bus 110, the processor 120, or the memory 130) of the computing device 101 to at least one of the application programs 157. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, or character control, as an interface capable of controlling a function provided by the application 157 in the kernel 151 or the middleware 153.

The application program 157 may include logic (e.g., hardware, software, firmware, etc.) that may be implemented to control, via the heating wire interface 130, the heating wire to heat the glass panel of the vehicle. For example, the application program 157 may be configured to learn over time a correlation between resistance values and temperature values associated with the glass panel in order to control the heating wire to control heat to the glass panel. The application program 157 may cause the computing device 101 to determine an initial resistance value associated with an initial temperature value associated with the glass panel based on a time duration associated with a vehicle power-up event. For example, the resistance value may be determined after a sufficient “soak time” since a last vehicle power-up. The initial resistance and temperature values may be determined when an interior temperature value of the vehicle is expected to be close to an exterior temperature value. When the vehicle is started and powered up, the application program 157 may cause the computing device 101 to determine if the “soak time” (e.g., time since last vehicle start or power-up) is longer than a calibrated threshold. If so, the application program 157 may cause the computing device 101 to compute and store the initial resistance value, in a lookup table for example. For example, a voltage and current of the heating wire may be determined, and the resistance value may be determined as a ratio between the voltage and current. The initial resistance value may be associated with the expected temperature value (e.g., initial temperature value). In one example, the initial resistance and temperature values may be determined based on measuring a difference between an interior temperature of the vehicle and an exterior temperature of the vehicle. In another example, the initial resistance and temperature values may be determined based on one or more ambient parameters. The one or more ambient parameters may comprise one or more of an ambient temperature, ambient pressure, ambient humidity, or ambient sun load. Based on the initial temperature value and the initial resistance value, the application program 157 may generate a filter (e.g., heating wire transfer function) that may be configured to output a temperature value associated with an exterior surface of the glass panel correlated to a resistance value, wherein the resistance value is calculated from a voltage and current of the heating wire.

The application program 157 may iteratively tune the filter based on one or more environmental values associated with an interior of the vehicle. For example, the application program 157 may cause the computing device 101 to determine (e.g., measure) each environmental value of the one or more environmental values at each time point of one or more time points. The application program 157 tune the filter based on each environmental value at each time point. The one or more environmental values may comprise one or more of one or more temperature values or one or more humidity values. In an example, one or more sensor devices 102 (e.g., one or more temperature sensors or one or more humidity/moisture sensors) may be configured to determine (e.g., measure) the one or more temperature values and the one or more humidity values. For example, the one or more sensor devices 102 may be provided at one or more locations of the vehicle. The computing device 101 may receive the one or more temperature values and/or the one or more humidity values from the one or more sensor devices at the one or more time points.

The application program 157 may iteratively update the tuned filter based on one or more resistance values and one or more temperature values associated with the glass panel. For example, the application program 157 may cause the computing device 101 to determine each resistance value of the one or more resistance values and each temperature value of the one or more temperature values associated with the glass panel at each time point of the one or more time points. The application program 157 may update the tuned filter based on each resistance value and each temperature value at each time point. Each iteration of updating the filter may increase an accuracy associated with the correlation of a temperature value to a resistance value. For example, the filter may update estimates of one or more temperature values (e.g., lookup table of temperature values) each time a resistance value and a temperature value is determined (e.g., at each time point). The filter may incorporate the error between the measured and estimated temperature values, and thus, the accuracy of the correlation between the temperature value and the resistance value may be increase by taking into account the error between the measured and estimated temperature values.

The updated filter may be used to determine a temperature value of the exterior surface of the glass panel. For example, the updated filter may receive a resistance value that is calculated based on a voltage and a current of the heating wire. Based on the resistance value, the filter may determine a temperature value of the exterior surface of the glass panel. For example, the application program 157 may apply the updated filter to the resistance value to determine the temperature value of the exterior surface of the glass panel. The application program 157 may cause the computing device 101 to control the heating wire to adjust the heat to the glass panel. For example, the computing device 101 may control the heating wire based on adjusting a power output to the heating wire. As an example, based on the temperature value exceeding a threshold temperature value, the application program 157 may cause the computing device 101 to control the heating wire to decrease the heat applied to the glass panel. As an example, based on the temperature value falling below a threshold temperature value, the application program 157 may cause the computing device 101 to control the heating wire to increase the heat applied to the glass panel. For example, the computing device 101 may receive user input for controlling the heating wire to adjust the heat applied to the glass panel based on an accumulation of frost, mist, or ice on the glass panel. The glass panel may be heated in order to defrost, demist, or deice the glass panel.

In an example, the computing device 101 may determine at least one divergence associated with at least one correlation between at least one temperature value and at least one resistance value based on iteratively updating the tuned filter. The filter may be iteratively tuned based on the one or more environmental values associated with the interior of the vehicle and based on the at least one divergence. The one or more conditions may comprise corrosion of a power distribution component or low integrity of one or more electrical connections.

The input/output interface 160 may be configured as an interface for delivering an instruction or data input from a user or a different external device(s) to the processor 120, the heating interface 130, the memory 140, the input/output interface 160, the display 170, and the communication interface 180. Further, the input/output interface 160 may output an instruction or data received from the processor 120, the heating interface 130, the memory 140, the input/output interface 160, the display 170, and/or the communication interface 180 to a different external device.

The display 170 may include various types of displays, such as, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 170 may display, for example, a variety of contents (e.g., text, image, video, icon, symbol, etc.) to the user. The display 170 may include a touch screen. For example, the display 170 may receive a touch, gesture, proximity, or hovering input by using a stylus pen or a part of a user's body.

The communication interface 180 may establish, for example, communication between the computing device 101 and an external device (e.g., the one or more sensor devices 102 or a server 106). For example, the communication interface 180 may communicate with the external device (e.g., the server 106) by being connected to a network 162 via wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include, for example, at least one of a telecommunications network, a computer network (e.g., LAN or WAN), the internet, and a telephone network.

In addition, the communication interface 180 may communicate with the external device (e.g., the one or more sensor devices 102) via a communication connection 164 such as a wireless communication and/or wired communication. The wireless communication may include, for example, a near-distance communication. The near-distance communications may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication may include, for example, at least one of Controller Area Network (CAN), Local Interconnect Network (LIN), Single Edge Nibble Transmission (SENT), FlexRay, Universal Serial Bus (USB), High Definition Multimedia Interface (HDMI), Recommended Standard-232 (RS-232), power-line communication, Plain Old Telephone Service (POTS), and the like.

The server 106 may comprise a group of one or more servers. In an example, all or some of the operations executed by the computing device 101 may be executed in a different one or a plurality of electronic devices (e.g., the one or more sensor devices 102 or the server 106). In an example, if the computing device 101 needs to perform a certain function or service either automatically or based on a request, the computing device 101 may request at least some parts of functions related thereto alternatively or additionally to a different electronic device (e.g., the one or more sensor devices 102 or the server 106) instead of executing the function or the service autonomously. The different electronic devices (e.g., the one or more sensor devices 102 or the server 106) may execute the requested function or additional function, and may deliver a result thereof to the computing device 101. The computing device 101 may provide the requested function or service either directly or by additionally processing the received result. For example, a cloud computing, distributed computing, or client-server computing technique may be used. In an example, the computing device 101 may receive sensor data (e.g., the environmental data such as temperature data or humidity data) from the one or more sensor devices 102 and resistance data determined based on voltage and current data of the heating wire and output the sensor data and the resistance data to the server 106. The server 106 may be configured to process the sensor data and the resistance data to determine temperature values associated with the exterior of the glass panel of the vehicle and output the temperature value to the computing device 101.

The generation of a filter that is continuously updated and tuned based on measurements obtained from various sensors such as environmental sensors of a vehicle and a heating wire used to heat a glass panel of the vehicle represent a technical improvement for vehicle glass panel heating wire systems by providing an adaptive learning approach that eliminates the need for conservative temperature margins and fixed heating cycles. Unlike traditional systems that rely on simple temperature threshold controls and proxy measurements, the computing may implement a sophisticated filter that learns correlations between heating wire resistance values and actual glass surface temperatures over time. The heating wire interface 130 may enable precise measurement of voltage and current values to calculate resistance, while the sensor devices 102 may provide environmental data from multiple vehicle locations to enhance the accuracy of temperature estimation. This integrated approach may allow the system to adaptively adjust to variations in glass panel characteristics, environmental conditions, and component aging effects without requiring extensive calibrations during manufacturing. The iterative learning capability may continuously refine the temperature-to-resistance correlation, enabling more precise control of heating elements while optimizing energy efficiency and maintaining effective defogging and deicing performance across varying operational conditions.

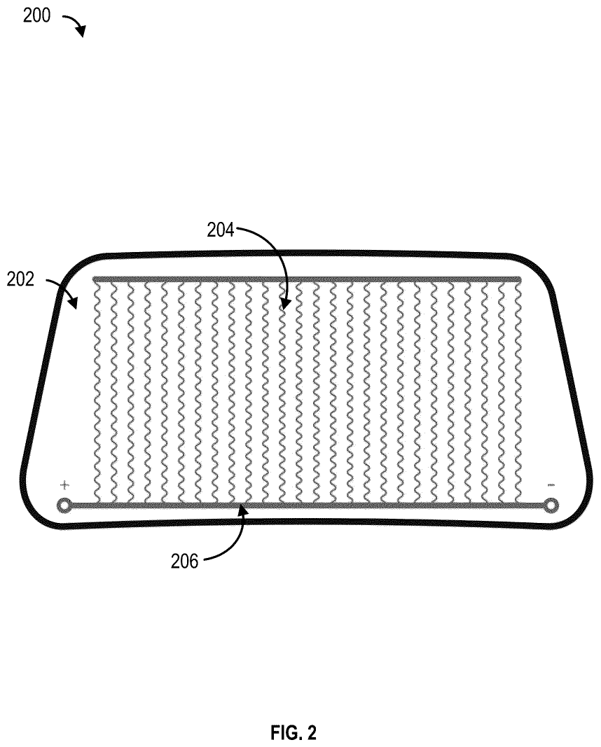

FIG. 2 shows an example heating wire configuration 200. As an example, a glass panel 202 of a vehicle may comprise heating wire 204 configured to heat the glass panel 202. For example, a computing device (e.g., computing device 101) may generate a filter (e.g., heating wire transfer function) configured to determine a temperature value of an exterior surface of the glass panel in order to control the heating wire 204 to adjust a temperature of the glass panel 202. For example, the computing device may control power output to the heating wire 204 to adjust heat (e.g., temperature) applied the glass panel 202, via the heating wire 204. For example, the filter may be configured to learn over time a correlation between resistance values and temperature values associated with an exterior surface of the glass panel 202 in order to control the heating wire 204 to control heat to the glass panel. The glass panel 202 may comprise a windshield, window, a glass pane, and the like of a vehicle (e.g., car, truck, automobile, SUV, electric vehicle, delivery vehicle, cargo vehicle, airplane, boat, etc.). The heating wire 204 may comprise wiggle wire, heating strips, a heating network, and the like affixed to a surface of the glass panel 202. In an example, the glass panel 202 may comprise integrated electric heating. For example, the assembly may be composed of two or more glass layers 202 on opposing sides of a metallic heating element 204 layer. The metallic heating element 204 may comprise a substrate of an array of thin resistive heating elements running between a panel's top and bottom edges where the individual strands are fixed to a common conductor 206 to which power is applied. The configuration of the heating wire 204, as shown in FIG. 2, is one example of a heating wire configuration. Any configuration of the heating wire 204 may be used to heat the glass panel 202. For example, the heating wire 204 may comprise wavy (e.g., wiggle wire) or straight and narrow strips. In addition, the heating wire 204 may be arranged vertically with a gap between neighboring strips, as shown in FIG. 2. As an example, fog, mist, or ice may accumulate on the glass panel 202 based on a temperature of the outside environment. The glass panel 202 may be heated, via the heating wire 204, to defrost, demist, or deice the glass panel 202. In an example, the computing device may determine a resistance value associated with the heating wire 204 based on a voltage and current of the heating wire 204. In an example, the computing device may measure a resistance of the heating wire 204 using an analog input circuit. The computing device may apply the filter to the determined resistance value to determine a temperature value associated with the exterior surface of the glass panel 202. As an example, based on the temperature value exceeding a threshold temperature value, the computing device may control the heating wire 204 to decrease the heat applied to the glass panel 202. As an example, based on the temperature value falling below a threshold temperature value, the computing device may control the heating wire 204 to increase the heat applied to the glass panel 202.

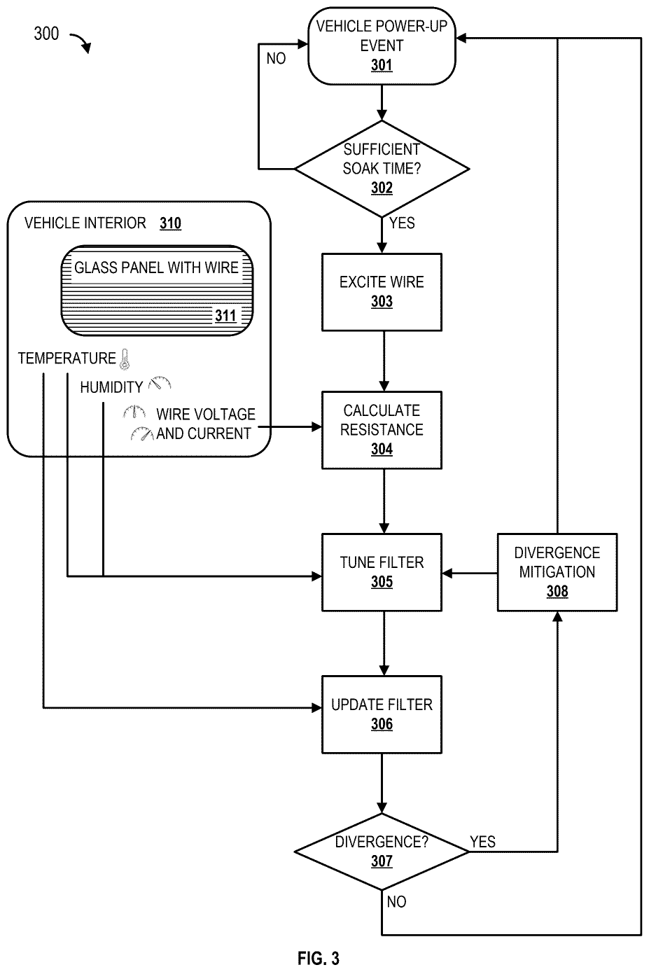

FIG. 3 shows an example process 300 for determining a temperature associated with an exterior surface of a glass panel (e.g., a windshield, window, glass pane, etc.) of a vehicle 310 (e.g., car, truck, automobile, SUV, electric vehicle, delivery vehicle, cargo vehicle, airplane, boat, etc.). At 301, a vehicle power-up event may be determined, wherein it may be determined whether the soak time has exceeded a time duration threshold at 302. For example, an initial temperature value may be determined based on an inside temperature measurement that is expected to be close to an outside temperature measurement. Thus, if the soak time (e.g., time since a last vehicle power-up) is longer than a time duration threshold, the initial temperature value may be stored. In one example, the initial temperature value may be determined based on measuring a difference between an interior temperature of the vehicle and an exterior temperature of the vehicle. In another example, the initial temperature value may be determined based on one or more ambient parameters. The one or more ambient parameters may comprise one or more of an ambient temperature, ambient pressure, ambient humidity, or ambient sun load. At 303, power may be output to the heating wire 311 (e.g., wiggle wire, heating strips, heating network, etc.) in order to determine a voltage and current of the heating wire 311. In an example, if the heating wire 311 is not already activated (e.g., based on user input via climate controls), the heating wire 311 may be activated for a time duration needed to obtain the voltage and current of the heating wire 311. At 304, a resistance value may be calculated based on the voltage and current of the heating wire 311. For example, the resistance value may be determined as a ratio between the voltage and current.

At 305, a filter may be tuned based on one or more environmental values associated with the vehicle 311. The one or more environmental values may comprise one or more of a temperature value and a humidity value associated with the vehicle 310. As an example, a heating wire transfer function (e.g., filter) may be defined as a lookup table with n resistance value breakpoints {R₁, . . . , Rₙ} that map to n temperature values {T₁, . . . , Tₙ}. The breakpoints and initial temperature values may be determined upfront (e.g., at steps 302-304). The lookup table may be used, by a computing device (e.g., computing device 101) for example, to control the power output to the heating wire 311. The heating wire transfer function may adaptively “learn” to correlate resistance values with temperature values. For example, the adaptive learning will change the temperature values to fit the observed data, which is used to adapt the heating wire transfer function to piece-to-piece variations and changes associated with the correlations of the resistance values to the temperature values over time. The filter may be tuned based on elements in a matrix Q and a scalar value R. The elements in the matrix Q may represent a process noise, a model of the drift of one or more parameters. In an example, the matrix Q is diagonal where the diagonal elements in Q may represent a process noise in each breakpoint of the lookup table with higher values implying faster drift of the parameter values. When some points are known to be more uncertain than others, the corresponding elements are set higher to reflect the uncertainty of the points. Moreover, if a divergence is detected (e.g., at step 307), Q may be increased with a factor during each subsequent iteration (e.g., at step 308). The increased elements in Q may allow the corresponding estimates to move faster towards the true values. R may represent a measurement noise where the value of R, relative to Q, may influence how much an estimate is affected by an update. For example, when R is large relative to Q, updates may change the estimates less than in situations when R is small relative to Q. Therefore, R is increased from a nominal value with a factor for samples with conditions where the measurement uncertainty is known to be larger, such as in certain temperature or humidity intervals. As an example, the diagonal matrix Q may start with diagonal elements comprising 0.1 (with other elements comprising 0) and R comprising 1. For any modification (of an individual element of Q matrix, or for R as described), a factor of 10 would be applied. For example, R may increase from 1 to 10 if an expected sample comprises a high measurement uncertainty. In addition, one or more diagonal elements in Q may increase from 0.1 to 1 if some points are known to be more uncertain than others. In an example, temperature and humidity values associated with the vehicle may be measured/determined by sensor devices (e.g., temperature sensors, humidity/moisture sensors, etc.) at one or more locations in the interior of the vehicle 310.

At 306, the filter may be updated based on a measured resistance value and measured a temperature value associated with the interior of the vehicle 310. As an example, at time k with the measured resistance value and the measured temperature value, denoted by rₖ and tₖ, the filter updates the estimates of the lookup table temperature values, denoted by \hat{x}ₖ={\hat{T}₁, . . . , \hat{T}ₙ}, and of a covariance matrix of the values, denoted by Pₖ. The filter is driven by the error, denoted by ∈ₖ, between the measured and estimated, denoted by \hat{t}ₖ, temperature values: ∈ₖ=tₖ−\hat{t}ₖ. A signal model is affine in \hat{x}ₖ with time-varying coefficients:

$${\hat{t}}_{k} = {C}_{k} {\hat{x}}_{k} = [ \begin{matrix}0 & ⋯ & 1 - {α}_{k} & {α}_{k} & … & 0\end{matrix} ] [ \begin{matrix}{\hat{T}}_{1} \\ ⋮ \\ {\hat{T}}_{i - 1} \\ {\hat{T}}_{i} \\ ⋮ \\ {\hat{T}}_{n}\end{matrix} ]$$

where

$${α}_{k} = \frac{{r}_{k} - {R}_{i - 1}}{{R}_{i} - {R}_{i - 1}}$$

and i is such that Rᵢ₋₁≤rₖ≤Rᵢ. A random-walk model is associated with an evolution of \hat{x}ₖ. Optimal updates are given by a linear time-varying Kalman Filter:

$${\hat{x}}_{k} = {\hat{x}}_{k} - 1 + {K}_{k} {ϵ}_{k} , {P}_{k} = {P}_{k - 1} + Q - {K}_{k} {L}_{k}$$

$$where$$

$${L}_{k} = ( {P}_{k - 1} + {Q}_{k} ) {C}_{k}^{T} , {S}_{k} = {C}_{k} {L}_{k} + R , {K}_{k} = {L}_{k} {S}_{k}^{- 1} .$$

At 307, divergence of the filter may be monitored. The filter performance is monitored by computing

$${z}_{k} = λ {z}_{k - 1} + ( 1 - λ ) {ϵ}_{k}^{T} {S}_{k}^{- 1} {ϵ}_{k} ,$$

where λ is a calibratable forgetting factor. If zₖ is outside a calibratable interval, the value of Q is increased, at 308, with a factor during several iterations to increase the probability of useful updates and steps 301-306 are repeated for each iteration of tuning and updating the filter. If zₖ is not outside the calibratable interval, the process repeats, starting from steps 301-306, wherein steps 301-306 are repeated for each iteration of tuning and updating the filter. Steps 301-306 may be repeated a threshold number of times until a desired level of accuracy associated with the correlation of the temperature values to the resistance values is achieved.

The process of continuously updating and tuning a filter based on measurements obtained from various sensors such as environmental sensors of a vehicle and a heating wire used to heat a glass panel of the vehicle represent a technical improvement for vehicle glass panel heating wire by providing an adaptive learning approach that eliminates the need for conservative temperature margins and fixed heating cycles. Unlike traditional systems that rely on simple temperature threshold controls and proxy measurements, the computing may implement a sophisticated filter that learns correlations between heating wire resistance values and actual glass surface temperatures over time. Voltage and current values may be measured to calculate resistance, while sensor devices may provide environmental data from multiple vehicle locations to enhance the accuracy of temperature estimation. This integrated approach may allow the system to adaptively adjust to variations in glass panel characteristics, environmental conditions, and component aging effects without requiring extensive calibrations during manufacturing. The iterative learning capability may continuously refine the temperature-to-resistance correlation, enabling more precise control of heating elements while optimizing energy efficiency and maintaining effective defogging and deicing performance across varying operational conditions.

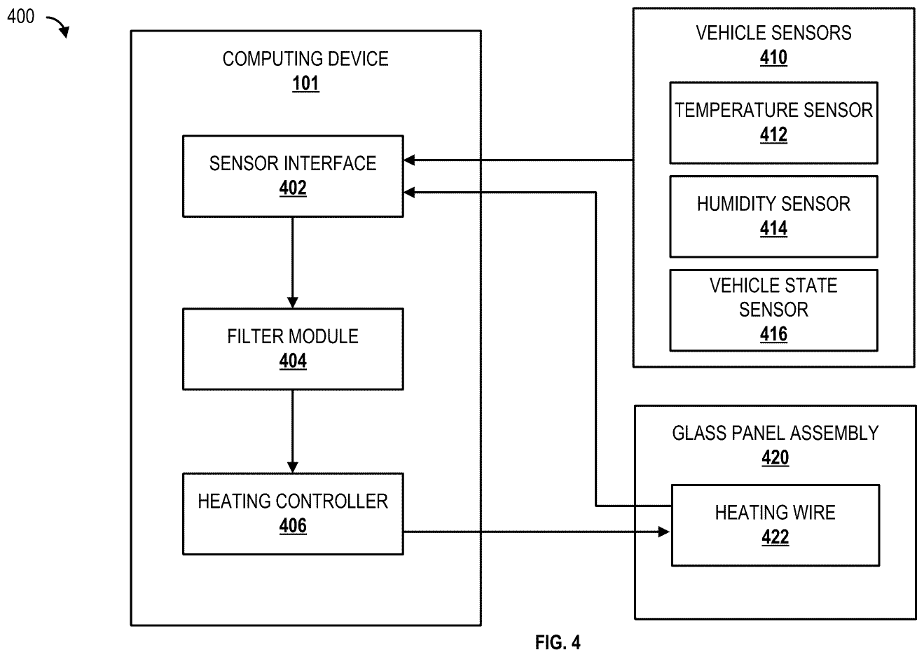

FIG. 4 shows an example temperature control system 400 for controlling a temperature of a glass panel (e.g., a windshield, window, a glass pane, etc.) of a vehicle (e.g., car, truck, automobile, SUV, electric vehicle, delivery vehicle, cargo vehicle, airplane, boat, etc.) based on determining a resistance value of a heating wire (e.g., heating wire, wiggle wire, heating strips, heating network, etc.) of the glass panel according to various embodiments. The temperature control system 400 may comprise a computing device 101, one or more vehicle sensors 410, and a glass panel assembly 420. The computing device 101 may comprise a sensor interface 402, a filter module 404, and a heating controller 406. The vehicle sensors 410 may comprise one or more temperature sensors 412, one or more humidity sensors 414, and a vehicle state sensor 416. The glass panel assembly 420 may comprise a heating wire 422. The sensor interface 404 may be communicatively coupled to the vehicle sensors 410 and the heating wire 422. For example, the sensor interface 404 may receive sensor data from the vehicle sensors 410 and the heating wire 422. For example, the sensor interface 404 may receive temperature data from the temperature sensors 412, humidity data from the humidity sensors 414, vehicle state data from the vehicle state sensor 416, and voltage and current data from the heating wire 422. As an example, the computing device 101 may determine an initial resistance value associated with an initial temperature value associated with the glass panel assembly 420 based on a time duration associated with a vehicle power-up event. For example, the vehicle power-up event may be determined based on the vehicle state data received from the vehicle state sensor 416. As an example, the resistance value may be determined after a sufficient “soak time” since a last vehicle power-up. For example, the initial resistance and temperature values may be determined when an interior temperature value of the vehicle is expected to be close to an exterior temperature value. When the vehicle state data, received from the vehicle state sensor 416, indicates that the vehicle is started and powered up, the computing device 101 may determine if the “soak time” (e.g., time since last vehicle start or power-up) is longer than a calibrated threshold. If so, the computing device 101 may compute and store the initial resistance value, in a lookup table for example. For example, the vehicle may determine initial voltage and current values of the heating wire 422, and the resistance value may be determined as a ratio between the initial voltage and current values. The initial resistance value may be associated with the expected temperature value (e.g., initial temperature value). In one example, the initial resistance and temperature values may be determined based on measuring a difference between an interior temperature of the vehicle and an exterior temperature of the vehicle. As an example, the temperature sensors 412 and the humidity sensors 414 may be provided at one or more locations of the vehicle. For example, the computing device 101 may receive the interior temperature from an interior temperature sensor of the one or more temperature sensors 412 and the exterior temperature from an exterior temperature sensor of the one or more temperature sensors 412 via the sensor interface 402. In another example, the initial resistance and temperature values may be determined based on one or more ambient parameters. The one or more ambient parameters may comprise one or more of an ambient temperature, ambient pressure, ambient humidity, or ambient sun load.

The computing device 101 may provide the sensor data received from the temperature sensors 412, the humidity sensors 414, the vehicle state sensor 416, and/or the heating wire 422 to the filter module 404. Based on the temperature value and the initial resistance value, the filter module 404 may generate a filter (e.g., heating wire transfer function) that may be configured to output a temperature value associated with an exterior surface of the glass panel assembly 420 correlated to a resistance value, wherein the resistance value is calculated from a voltage and current of the heating wire 422. The filter module 404 may iteratively tune the filter based on one or more environmental values associated with an interior of the vehicle. For example, the computing device 101 may determine (e.g., measure) each environmental value of the one or more environmental values, received from the temperature sensors 412 and the humidity sensors 414, at each time point of one or more time points. As an example, the temperature sensors 412 and the humidity sensors 414 may be provided at one or more locations of the vehicle. The filter module 404 may tune the filter based on each environmental value at each time point. The one or more environmental values may comprise one or more of one or more temperature values or one or more humidity values received from the temperature sensors 412 and the humidity sensors 414.

The filter module 404 may iteratively update the tuned filter based on one or more resistance values and one or more temperature values associated with the glass panel assembly 420. For example, the filter module 404 may determine each resistance value of the one or more resistance values and each temperature value of the one or more temperature values associated with the glass panel assembly 420 at each time point of the one or more time points. The filter module 404 may update the tuned filter based on each resistance value and each temperature value at each time point. Each iteration of updating the filter may increase an accuracy associated with the correlation of a temperature value to a resistance value. For example, the filter module 404 may update estimates of one or more temperature values (e.g., lookup table of temperature values) each time a resistance value and a temperature value is determined (e.g., at each time point). The filter module 404 may incorporate the error between the measured and estimated temperature values, and thus, the accuracy of the correlation between the temperature value and the resistance value may be increase by taking into account the error between the measured and estimated temperature values.

The updated filter may be used to determine a temperature value of the exterior surface of the glass panel assembly 420. For example, the updated filter may receive a resistance value that is calculated based on a voltage and a current of the heating wire 422. Based on the resistance value, the filter may determine a temperature value of the exterior surface of the glass panel assembly 420. For example, the filter module 404 may apply the updated filter to the resistance value to determine the temperature value of the exterior surface of the glass panel. The filter module 404 may control the heating wire to adjust the heat to the glass panel. For example, the computing device 101 may control the heating wire 422 based on adjusting a power output to the heating wire 422 via the heating controller 406. As an example, based on the temperature value exceeding a threshold temperature value, the computing device 101 may control the heating wire 422, via the heating controller 406, to decrease the heat applied to the glass panel assembly 420. As an example, based on the temperature value falling below a threshold temperature value, the computing device 101 may control the heating wire 422, via the heating controller 406, to increase the heat applied to the glass panel assembly 420. For example, the computing device 101 may receive user input for controlling the heating wire 422 to adjust the heat applied to the glass panel assembly 420 based on an accumulation of frost, mist, or ice on the glass panel. The glass panel assembly 420 may be heated in order to defrost, demist, or deice the glass panel.

In an example, the computing device 101 may determine at least one divergence associated with at least one correlation between at least one temperature value and at least one resistance value based on iteratively updating the tuned filter. The filter may be iteratively tuned based on the one or more environmental values associated with the interior of the vehicle and based on the at least one divergence. The one or more conditions may comprise corrosion of a power distribution component or low integrity of one or more electrical connections.

The generation of a filter that is continuously updated and tuned based on measurements obtained from various sensors such as environmental sensors of a vehicle and a heating wire used to heat a glass panel of the vehicle represent a technical improvement for vehicle glass panel heating wire by providing an adaptive learning approach that eliminates the need for conservative temperature margins and fixed heating cycles. Unlike traditional systems that rely on simple temperature threshold controls and proxy measurements, the computing may implement a sophisticated filter that learns correlations between heating wire resistance values and actual glass surface temperatures over time. The heating wire 422 may enable precise measurement of voltage and current values to calculate resistance, while the vehicle sensors 410 may provide environmental data from multiple vehicle locations to enhance the accuracy of temperature estimation. This integrated approach may allow the system to adaptively adjust to variations in glass panel characteristics, environmental conditions, and component aging effects without requiring extensive calibration during manufacturing. The iterative learning capability may continuously refine the temperature-to-resistance correlation, enabling more precise control of heating elements while optimizing energy efficiency and maintaining effective defogging and deicing performance across varying operational conditions.

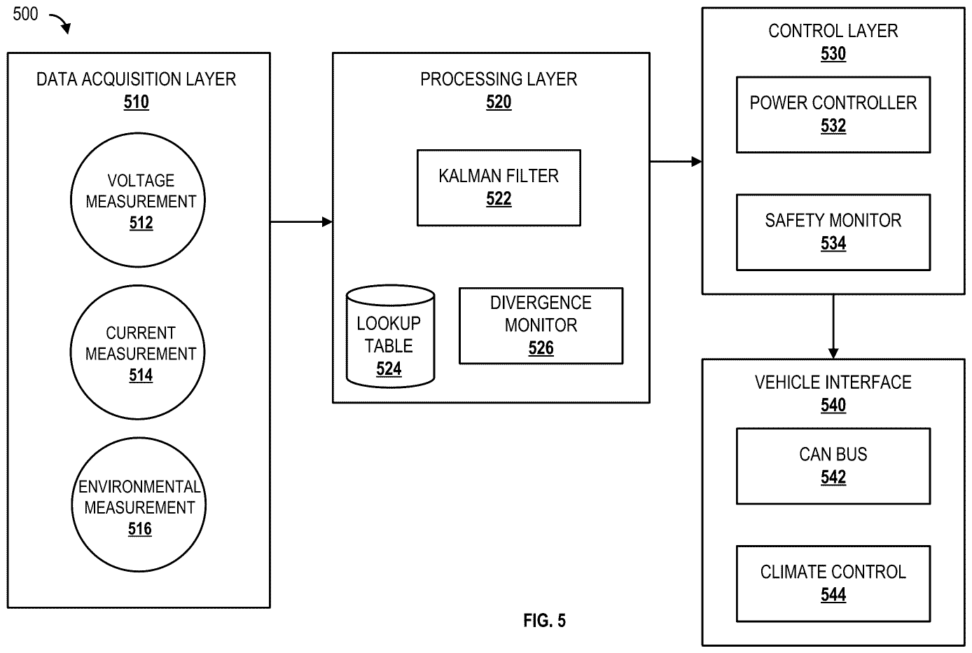

FIG. 5 shows an example adaptive learning control architecture 500 for controlling a temperature of a glass panel (e.g., a windshield, window, a glass pane, etc.) of a vehicle (e.g., car, truck, automobile, SUV, electric vehicle, delivery vehicle, cargo vehicle, airplane, boat, etc.) based on determining a resistance value of a heating wire (e.g., heating wire, wiggle wire, heating strips, heating network, etc.) of the glass panel according to various embodiments. In an example, a computing device (e.g., computing device 101) may be configured according to the adaptive learning control architecture 500. The adaptive learning control architecture 500 may comprise one or more data layers that work together to provide intelligent temperature control through data acquisition, processing, control, and vehicle interface functions. For example, the adaptive learning control architecture 500 may comprise a data acquisition layer 510, a processing layer 520, a control layer 530, and a vehicle interface 540.

The data acquisition layer 510 may comprise a voltage measurement module 512, a current measurement module 514, and an environmental measurement module 516. The voltage measurement module 512 may be configured to monitor the electrical voltage applied to the heating wire. The current measurement module 514 may be configured to monitor/track the electrical current flowing through the heating wire. The environmental measurement module 516 may be configured to monitor/collect environmental data such as temperature and humidity values from the vehicle interior.

The processing layer 520 may receive data, comprising the voltage measurements, the current measurements, and the environmental measurements, from the data acquisition layer 510. The processing layer 520 may be configured to implement adaptive learning functions based on the data received from the data acquisition layer 510. The processing layer 520 may comprise Kalman filter module 522, a lookup table database 524, and a divergence monitor module 526. The Kalman filter module 522 may be configured to process the voltage measurements, the current measurements, and the environmental measurements to generate refined estimates and correlations between resistance values and temperature values. The lookup table database 524 may be configured to store a resistance-to-temperature mapping based on the measurements that is continuously updated through the adaptive learning process. The divergence monitor module 526 may be configured to track a performance of the filter and detect when adjustments are needed to maintain accurate temperature estimates associated with the glass panel of the vehicle. As an example, a feedback mechanism may be implemented, wherein the divergence monitor module 526 may provide feedback to the Kalman filter module 522 in order to enable the processing layer 520 to adapt and improve the accuracy of the temperature estimates over time based on detected performance variations.

The control layer 530 may be configured to control the heating wire based on the processed voltage, current, and environmental measurements received from the processing layer 520. The control layer 530 may comprise a power controller 532 and a safety monitor module 534. The power controller 530 may receive temperature estimates from the lookup table 524 and adjust the power output to the heating wire based on the temperature estimates. The safety monitor 534 may be configured to interrupt the power controller 532 to ensure safe operating conditions and prevent the heating wire from overheating or other potentially damaging conditions.

The vehicle interface 540 may be configured to provide communication between the adaptive learning control architecture 500 and one or more vehicle systems (e.g., air conditioning, heating, defrost, etc.). The vehicle interface 540 may comprise a CAN bus interface 542 and a climate control interface 544. The CAN bus interface 542 may be configured to enable data exchange with the one or more vehicle systems. The climate control interface 542 may be configured to interface with the vehicle's climate management system to coordinate heating operations.

The implementation of a layered data architecture eliminates the need for additional temperature sensors while providing precise thermal control. The data acquisition layer 510 may enable real-time measurement of electrical parameters through voltage measurement and current measurement components, while the environmental measurement module 516 may capture contextual data that traditional systems typically ignore, allowing for more accurate correlation between heating wire resistance and actual glass surface temperatures. The processing layer 520 may implement advanced signal processing through the Kalman filter module 522 that continuously refines the resistance-to-temperature mapping stored in the lookup table database 524, while the divergence monitor module 526 may detect and compensate for system drift and component aging effects that degrade performance in conventional systems. The control layer 530 may provide intelligent power management through the power controller 532 that responds to real-time temperature estimates rather than predetermined heating cycles, while the safety monitor module 534 may prevent the overheating conditions that can result from conservative temperature margins used in traditional approaches. The vehicle interface 540 may integrate the heating control with broader vehicle systems through the CAN bus interface 542 and the climate control interface 542, enabling coordinated operation that optimizes energy efficiency across multiple vehicle subsystems. The feedback between the divergence monitor module 526 and the Kalman filter module 522 may enable continuous adaptation to changing environmental conditions and component characteristics, providing a self-correcting system that maintains accuracy over time without requiring manual recalibration or conservative safety margins that waste energy in conventional glass heating systems.

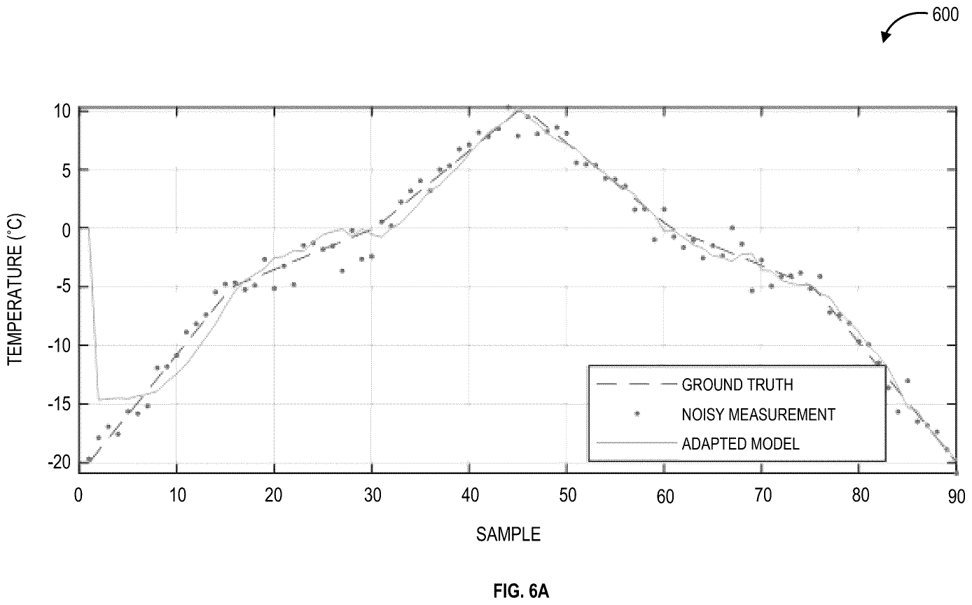

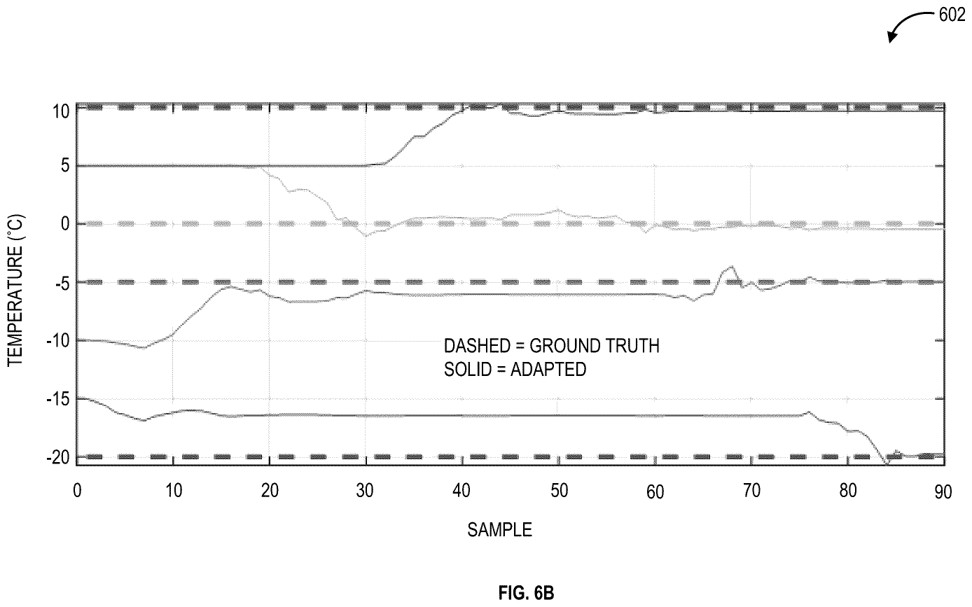

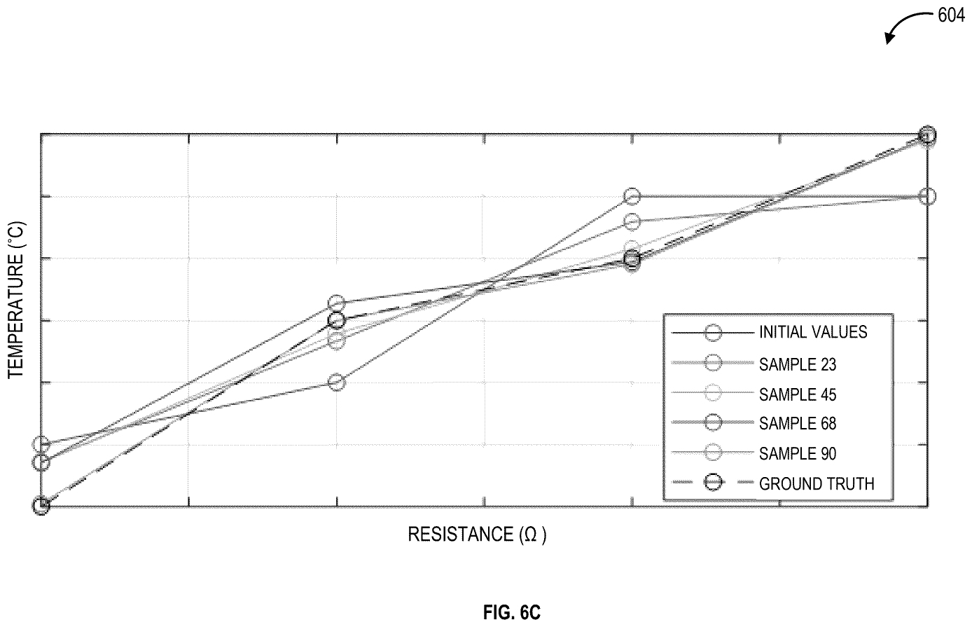

FIGS. 6A-6C show example tables 600, 602, 604 of determined temperature samples based on an example filter adaption to a ground truth of measured temperature values. FIG. 6A shows an example table 600 of measured temperature samples. The noisy measurements (e.g., dots) may comprise the ground truth temperature values (e.g., dashed blue) with added random noise. The solid line may comprise the estimated temperature values output by the filter and stored in the lookup table. As shown in FIG. 6A, a temperature error is relatively large in the beginning and converges to the ground truth as samples are observed and processed. FIG. 6B shows an example table 602 of temperature values output by the filter and stored in the lookup table {T₁, . . . , Tₙ}, wherein n=4. As shown in FIG. 6B, the estimated/adapted temperature values (e.g., solid lines) converge to the ground truth temperature values (e.g., dashed lines). FIG. 6C shows the estimated temperature values {T₁, . . . , Tₙ} output by the filter and stored in the lookup table mapped to the resistance value breakpoints {R₁, . . . , Rₙ}.

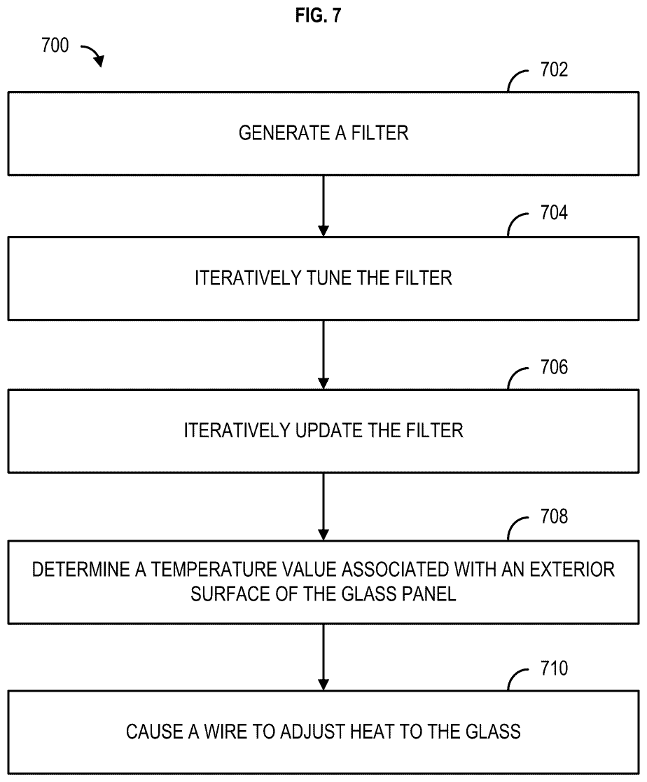

FIG. 7 shows a flowchart of an example method 700. The method 700 may be implemented by a computing device (e.g., computing device 101, etc.). At step 702, a filter, that is configured to output a temperature value associated with an exterior surface of a glass panel of a vehicle correlated to a resistance value associated with a voltage and current of a wire of the glass panel, may be generated based on a resistance value and a temperature value associated with the glass panel. For example, a computing device (e.g., computing device 101, etc.) may generate the filter, that is configured to output the temperature value associated with the exterior surface of the glass panel (e.g., a windshield, window, glass pane, etc.) of the vehicle (e.g., car, truck, automobile, SUV, electric vehicle, delivery vehicle, cargo vehicle, airplane, boat, etc.) correlated to the resistance value associated with the voltage and current of the wire of the glass panel, based on the resistance value (e.g., initial resistance value) and the temperature value (e.g., initial temperature value) associated with the glass panel. As an example, the filter (e.g., heating wire transfer function) may be defined as a lookup table with n resistance value breakpoints {R₁, . . . , Rₙ)} that map to n temperature values {T₁, . . . , Tₙ}. The glass panel may comprise a wire (e.g., heating wire, wiggle wire, heating strips, heating network, etc.) affixed to a surface of the glass panel, wherein the wire is configured to heat the glass panel.

As an example, the resistance value may be determined based on the temperature value associated with the glass panel. The temperature value associated with the glass panel may be determined based on a time duration since a last vehicle power-up event. For example, an initial resistance value and an initial temperature value may be determined after a sufficient “soak time” since a last vehicle power-up. The initial resistance and temperature values may be determined when an interior temperature value of the vehicle is expected to be close to an exterior temperature value. When the vehicle is started and powered up, it may be determined if the “soak time” (e.g., time since last vehicle start or power-up) is longer than a calibrated threshold. If so, the initial resistance value may be calculated and stored. For example, a voltage and current of the wire may be determined, and the resistance value may be determined as a ratio between the voltage and current. The initial resistance value may be associated with the expected temperature value (e.g., initial temperature value). In one example, the initial resistance and temperature values may be determined based on measuring a difference between an interior temperature of the vehicle and an exterior temperature of the vehicle. In another example, the initial resistance and temperature values may be determined based on one or more ambient parameters. The one or more ambient parameters may comprise one or more of an ambient temperature, ambient pressure, ambient humidity, or ambient sun load.

At step 704, the filter may be iteratively tuned based on one or more environmental values associated with an interior of the vehicle. For example, the computing device (e.g., computing device 101, etc.) may iteratively tune the filter based the on one or more environmental values associated with the interior of the vehicle. The one or more environmental values may comprise one or more temperature values or one or more humidity values. As an example, each environmental value of the one or more environmental values associated with the interior of the vehicle may be determined at each time point of one or more time points. For example, the filter may adaptively “learn” to correlate resistance values with temperature values. For example, the adaptive learning will change the temperature values to fit the observed data, which is used to adapt the heating wire transfer function to piece-to-piece variations and changes associated with the correlations of the resistance values to the temperature values over time. Thus, the filter may be tuned based on each environmental value at each time point.

At step 706, the tuned filter may be iteratively updated based on one or more resistance values and one or more temperature values associated with the glass panel. For example, the computing device (e.g., computing device 101, etc.) may iteratively update the tuned filter based on the one or more resistance values and the one or more temperature values associated with the glass panel. Each iteration of updating the filter may increase an accuracy associated with the correlation of a temperature value to a resistance value. As an example, the filter may update estimates of the lookup table temperature values at a time point of one or more time points based on a measured resistance value and a measured temperature value. For example, each resistance value of the one or more resistance values and each temperature value of the one or more temperature values associated with the glass panel may be determined at each time point of one or more time points. The filter may be updated based on each resistance value and each temperature value at each time point. In an example, at least one divergence associated with at least one correlation between at least one temperature value and at least one resistance value may be determined based on iteratively updating the tuned filter. The filter may be iteratively tuned based on the one or more environmental values associated with the interior of the vehicle and based on the at least one divergence. In addition, one or more conditions associated with the glass panel may be determined based on the at least one divergence. The one or more conditions may comprise corrosion in a power distribution component or low integrity of an electrical connection.

At step 708, a temperature value associated with the exterior surface of the glass panel may be determined based on an application of the updated filter to a resistance value. For example, the computing device (e.g., computing device 101, etc.) may determine the temperature value associated with the exterior surface of the glass panel based on the application of the updated filter to the resistance value.

At step 710, the wire may be caused to adjust heat to the glass panel based on the temperature value associated with the exterior surface of the glass panel. For example, the computing device (e.g., computing device 101, etc.) may cause the wire to adjust the heat to the glass panel based on the temperature value associated with the exterior surface of the glass panel. As an example, the computing device may cause the wire to adjust the heat to the glass panel based on adjusting a power output to the wire. As an example, based on the temperature value exceeding a threshold temperature value, the computing device may control the heating wire to decrease the heat applied to the glass panel. As an example, based on the temperature value falling below a threshold temperature value, the computing device may control the wire to increase the heat applied to the glass panel. For example, the computing device may receive user input for controlling the heating wire to adjust the heat applied to the glass panel based on an accumulation of frost, mist, or ice on the glass panel. The glass panel may be heated in order to defrost, demist, or deice the glass panel.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A vehicle comprising:
a glass panel comprising a wire configured to heat the glass panel; and
a computing device in communication with the glass panel, wherein the computing device is configured to:
generate, based on a resistance value and a temperature value associated with the glass panel, a filter configured to output a temperature value associated with an exterior surface of the glass panel correlated to a resistance value associated with a voltage and current of the wire,
iteratively tune the filter based on one or more environmental values associated with an interior of the vehicle,
iteratively update the tuned filter based on one or more resistance values and one or more temperature values associated with the glass panel,
determine, based on an application of the updated filter to a resistance value, a temperature value associated with the exterior surface of the glass panel, and
cause, based on the temperature value associated with the exterior surface of the glass panel, the wire to adjust the heat to the glass panel.

2. The vehicle of claim 1, wherein the computing device is further configured to:
determine, based on a time duration since a last vehicle power-up event, the temperature value associated with the glass panel; and
determining, based on the temperature value, the resistance value.

3. The vehicle of claim 1, wherein the computing device is further configured to:
determine, based on a difference between an interior temperature of the vehicle and an exterior temperature of the vehicle, the temperature value associated with the glass panel; and
determining, based on the temperature value, the resistance value.

4. The vehicle of claim 1, wherein the computing device is further configured to:
determine, based on one or more ambient parameters, the temperature value associated with the glass panel, wherein the ambient parameters comprise one or more of an ambient temperature, ambient pressure, ambient humidity, or ambient sun load; and
determining, based on the temperature value, the resistance value.

5. The vehicle of claim 1, wherein the one or more environmental values comprise one or more of one or more temperature values or one or more humidity values.

6. The vehicle of claim 1, wherein the computing device is further configured to:
determine, at each time point of one or more time points, each environmental value of the one or more environmental values associated with the interior of the vehicle.

7. The vehicle of claim 1, wherein the computing device is further configured to:
determine, based on iteratively updating the tuned filter, at least one divergence associated with at least one correlation between at least one temperature value and at least one resistance value.

8. The vehicle of claim 7, wherein the computing device is configured to iteratively tune the filter based on the one or more environmental values associated with the interior of the vehicle, the computing device is further configured to:
iteratively tune the filter based on the one or more environmental values associated with the interior of the vehicle and based on the at least one divergence.

9. The vehicle of claim 7, wherein the computing device is further configured to determine, based on the at least one divergence, one or more conditions associated with the glass panel, wherein the one or more conditions comprise corrosion of a power distribution component or low integrity of one or more electrical connections.

10. The vehicle of claim 1, wherein the computing device is configured to cause the wire to adjust the heat to the glass panel based on adjusting a power output to the wire.

11. A method comprising:
generating, by a computing device, based on a resistance value and a temperature value associated with a glass panel of a vehicle, a filter configured to output a temperature value associated with an exterior surface of the glass panel correlated to a resistance value associated with a voltage and current output of a wire of the glass panel;
iteratively tuning the filter based on one or more environmental values associated with an interior of the vehicle;
iteratively updating the tuned filter based on one or more resistance values and one or more temperature values associated with the glass panel;
determining, based on an application of the updated filter to a resistance value, a temperature value associated with the exterior surface of the glass panel; and
causing, based on the temperature value associated with the exterior surface of the glass panel, the wire to adjust heat to the glass panel.

12. The method of claim 11, further comprising:
determining, based on a time duration since a last vehicle power-up event, the temperature value associated with the glass panel; and
determining, based on the temperature value, the resistance value.

13. The method of claim 11, further comprising:
determining, based on a difference between an interior temperature of the vehicle and an exterior temperature of the vehicle, the temperature value associated with the glass panel; and
determining, based on the temperature value, the resistance value.

14. The method of claim 11, further comprising:
determining, based on one or more ambient parameters, the temperature value associated with the glass panel, wherein the ambient parameters comprise one or more of an ambient temperature, ambient pressure, ambient humidity, or ambient sun load; and
determining, based on the temperature value, the resistance value.

15. The method of claim 11, wherein the one or more environmental values comprise one or more temperature values or one or more humidity values.

16. The method of claim 11, further comprising:
determining, at each time point of one or more time points, each environmental value of the one or more environmental values associated with the interior of the vehicle.

17. The method of claim 11, further comprising:
determining, based on iteratively updating the tuned filter, at least one divergence associated with at least one correlation between at least one temperature value and at least one resistance value.

18. The method of claim 17, wherein iteratively tuning the filter based on the one or more environmental values associated with the interior of the vehicle comprises iteratively tuning the filter based on the one or more environmental values associated with the interior of the vehicle and based on the at least one divergence.

19. The method of claim 17, further comprising:
determining, based on the at least one divergence, one or more conditions associated with the glass panel, wherein the one or more conditions comprise corrosion in a power distribution component or low integrity of an electrical connection.

20. The method of claim 11, wherein causing the wire to adjust the heat to the glass panel comprises causing, based on adjusting a power output to the wire, the wire to adjust the heat to the glass panel.
